(19) United States
(12) Patent Application Publication
(10) Pub. No.: US 2025/0214805 A1
(43) Pub. Date: Jul. 3, 2025

(54) REEL TAKE-OUT DEVICE AND METHOD

(71) Applicant: SEMES CO., LTD., Chungcheongnam-do (KR)

(72) Inventors: Jae Hee HWANG, Gyeonggi-do (KR); Seung Won KIM, Gyeonggi-do (KR)

(21) Appl. No.: 19/002,578

(22) Filed: Dec. 26, 2024

(30) Foreign Application Priority Data
Dec. 27, 2023 (KR) 10-2023-0192784

(51) Int. Cl. B65H 67/04

(52) U.S. Cl. CPC B65H 67/0411

(57) ABSTRACT

A reel take-out device and method is provided, in which a reel may be taken out in response to an arrangement angle of a shaft of a transport cart to prevent the reel from being damaged during a take-out process and to increase take-out workability. The reel take-out device comprises a gripper unit gripping a reel core of one or more reels sequentially fitted to a shaft of a transport cart; a first driving unit connected to the gripper unit to elevate the gripper unit in a first direction; a second driving unit connected to the first driving unit to move the first driving unit in a second direction; and a controller controlling driving of the gripper unit, the first driving unit and the second driving unit, wherein the controller controls the first and second driving units to be simultaneously driven to take out the reel in response to an arrangement angle of the shaft along the second direction in a state that the gripper unit grips the reel core.

### CROSS-REFERENCE TO RELATED APPLICATION

This application claims priority from Korean Patent Application No. 10-2023-0192784 filed on Dec. 27, 2023, in the Korean Intellectual Property Office and all the benefits accruing therefrom under 35 U.S.C. 119, the contents of which in its entirety are herein incorporated by reference.

### BACKGROUND

### Technical Field

The present disclosure relates to a reel-take-out device and method.

### Description of the Related Art

In the process of manufacturing a battery, a raw material for manufacturing the battery or a manufactured battery is transferred to next process in the form of a reel wound on a hollow core.

The raw material or battery supplied in the form of a reel is bulky and has high load, so that a worker cannot carry it manually, whereby the raw material or battery is carried between processes using a separate transport cart.

The transport cart may operate manually by the worker depending on an operating mode or may operate by following an input program, and many transport carts move while being mounted with one or more reels.

However, in the process of mounting a reel in the transport cart or supplying the mounted reel to a production equipment, since the worker directly checks a position or direction of the reel, the time required for work has been increased and the worker's labor cost has been increased.

Meanwhile, it is general that a shaft of the transport cart into which one or more reels are fitted is disposed upward at a certain angle (e.g., 0.2°) in accordance with a driving direction of the transport cart in response to high load of the reel.

When the shaft of the transport cart, which is disposed upward at a certain angle or nonetheless multiple reels are fitted thereto so that it may be switched to a downward arrangement state, is intended to take out the reel in a straight line by gripping a core of the reel, the core of the reel and the shaft may be caught in or fitted to each other, whereby the reel may not be taken out or the gripped core of the reel may be missed during the process of taking out the reel. For this reason, the reel may be damaged, and it is difficult to take out the reel, whereby workability may be deteriorated.

### BRIEF SUMMARY

An object of the present disclosure is to provide a reel take-out device and method in which a reel may be taken out in response to an arrangement angle of a shaft of a transport cart to prevent the reel from being damaged during a take-out process and to increase take-out workability.

The objects of the present disclosure are not limited to those mentioned above and additional objects of the present disclosure, which are not mentioned herein, will be clearly understood by those skilled in the art from the following description of the present disclosure.

A reel take-out device according to one aspect of the present disclosure devised to achieve the above objects comprises a gripper unit gripping a reel core of one or more reels sequentially fitted to a shaft of a transport cart; a first driving unit connected to the gripper unit to elevate the gripper unit in a first direction; a second driving unit connected to the first driving unit to move the first driving unit in a second direction; and a controller controlling driving of the gripper unit, the first driving unit and the second driving unit, wherein the controller controls the first and second driving units to be simultaneously driven to take out the reel in response to an arrangement angle of the shaft along the second direction in a state that the gripper unit grips the reel core.

A reel take-out device according to another aspect of the present disclosure devised to achieve the above objects comprises a gripper unit gripping a reel core of one or more reels sequentially fitted to a shaft of a transport cart; a first driving unit connected to the gripper unit to elevate the gripper unit in a first direction; a second driving unit connected to the first driving unit to move the first driving unit in a second direction; a controller controlling driving of the gripper unit, the first driving unit and the second driving unit; and a sensor unit protruded from a lower portion of the first driving unit along the first direction toward one side directed toward the transport cart along the second direction, wherein the sensor unit is connected to the controller, and includes a first sensor mapping a position to which the reel is fitted, while counting the number of the reels fitted to the shaft in accordance with movement of the first driving unit in the second direction by the second driving unit, a second sensor sensing an outer circumferential surface of the reel core, and a third sensor sensing an outer circumferential surface of the shaft, the first sensor, the second sensor and the third sensor have a form of a displacement sensor, the controller determines an error state that the second sensor does not sense the outer circumferential surface of the reel core, which is covered by the reel, during a winding defect of the reel, determines an error state that both the second sensor and the third sensor sense the outer circumferential surface of the reel core when the first driving unit is excessively moved in the second direction, determines an error state that both the second sensor and the third sensor sense the outer circumferential surface of the shaft when the first driving unit is slightly moved in the second direction, calculates a difference value between heights of the reel core and the shaft, which are sensed by the second sensor and the third sensor, and controls the first and second driving units to be simultaneously driven in accordance with the difference value to take out the reel in response to an arrangement angle of the shaft along the second direction in a state that the gripper unit grips the reel core.

A reel take-out method according to one aspect of the present disclosure devised to achieve the above objects comprises providing a reel take-out device including a gripper unit gripping a reel core of one or more reels sequentially fitted to a shaft of a transport cart; a first driving unit connected to the gripper unit to elevate the gripper unit in a first direction; a second driving unit connected to the first driving unit to move the first driving unit in a second direction; a controller controlling driving of the gripper unit, the first driving unit and the second driving unit; and a sensor unit protruded from a lower portion of the first driving unit along the first direction toward one side directed toward the transport cart along the second direction; mapping a position to which the reel is fitted, while counting the number of the reels fitted to the shaft by a first sensor of the sensor unit in accordance with movement of the first driving unit to one side along the second direction by the controller; moving the first driving unit to the other side again along the second direction by the controller to return to its original position; moving the first driving unit along the second direction by the controller so that the first driving unit is disposed at a positon corresponding to the reel core of the reel on the other side of the shaft along the second direction; determining a winding defect of the reel and excessive or slight movement of the first driving unit along the second direction through sensing of a second sensor and a third sensor of the sensor unit by the controller; calculating a difference value between heights of the reel core and the shaft, which are sensed by the second sensor and the third sensor, by the controller; descending the gripper unit from the first driving unit by the controller; gripping the reel core by the gripper unit through the controller; and controlling the first and second driving units to be simultaneously driven in accordance with the difference value through the controller to take out the reel in response to an arrangement angle of the shaft along the second direction and transfer the reel to a port.

Details of the other embodiments are included in the detailed description and drawings.

In the reel take-out device and method according to some embodiments of the present disclosure, the difference value between the heights of the reel core and the shaft may be calculated by the sensor unit, and the first and second driving units may be controlled to be simultaneously driven in accordance with the difference value between the heights to take out the reel while corresponding to the arrangement angle of the shaft of the transport cart, thereby preventing the reel from being damaged and increasing efficiency of the take-out work of the reel.

The effects according to the embodiment of the present disclosure are not limited to those mentioned above, and more various effects are included in the following description of the present disclosure.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic perspective view illustrating a reel take-out device according to one embodiment of the present disclosure;

FIG. 2 is a schematic partial perspective view illustrating a gripper unit of a reel take-out device according to some embodiments of the present disclosure;

FIGS. 3 and 4 are schematic cross-sectional views illustrating a reel take-out device according to some embodiments of the present disclosure;

FIG. 5 is a schematic conceptual view illustrating a connection relation between a controller of a reel take-out device and each component according to some embodiments of the present disclosure;

FIG. 6 is a schematic partial cross-sectional view illustrating a sensor unit of a reel take-out device according to some embodiments of the present disclosure;

FIGS. 7 to 10 are schematic partial cross-sectional views illustrating that sensors of a sensor unit of a reel take-out device according to some embodiments of the present disclosure sense a winding defect state of a reel and the degree of excessive or slight movement of a first driving unit;

FIG. 11 is a partial cross-sectional view illustrating that a sensor unit of a reel take-out device according to some embodiments of the present disclosure senses heights of a reel core and a shaft;

FIG. 12 is a schematic flow chart illustrating a reel take-out method according to some embodiments of the present disclosure; and

FIGS. 13 to 18 are schematic perspective views illustrating a reel take-out method according to some embodiments of the present disclosure.

### DETAILED DESCRIPTION OF THE DISCLOSURE

Hereinafter, the preferred embodiment of the present disclosure will be described in detail with reference to the accompanying drawings. Advantages and features of the present disclosure and methods of achieving the advantages and features will be apparent from the following embodiments that will be described in more detail with reference to the accompanying drawings. It should be noted, however, that the present disclosure is not limited to the following embodiments, and may be implemented in various forms. The embodiments are provided only to disclose the present disclosure and let those skilled in the art understand the scope of the present disclosure. In the drawings, the embodiments of the present disclosure are defined by the scope of claims. The same reference numerals denote the same elements throughout the specification.

The terms used herein are for the purpose of embodiments, and are not intended to be limit the present disclosure. In the present disclosure, unless referred to the contrary, the singular forms are intended to include the plural forms. The terms “comprises” and/or “comprising” used herein specify the presence of stated elements, steps, operations and/or targets but do not preclude the presence or addition of one or more other elements, steps, operations and/or targets.

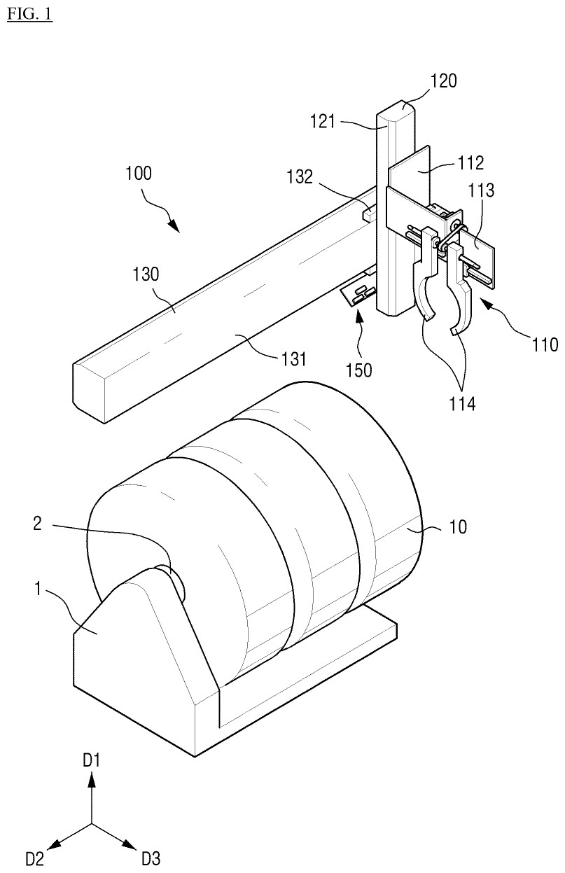

FIG. 1 is a schematic perspective view illustrating a reel take-out device according to one embodiment of the present disclosure.

Referring to FIG. 1, the reel take-out device 100 according to some embodiments of the present disclosure may include a gripper unit 110, a first driving unit 120, a second driving unit 130, and a controller 140.

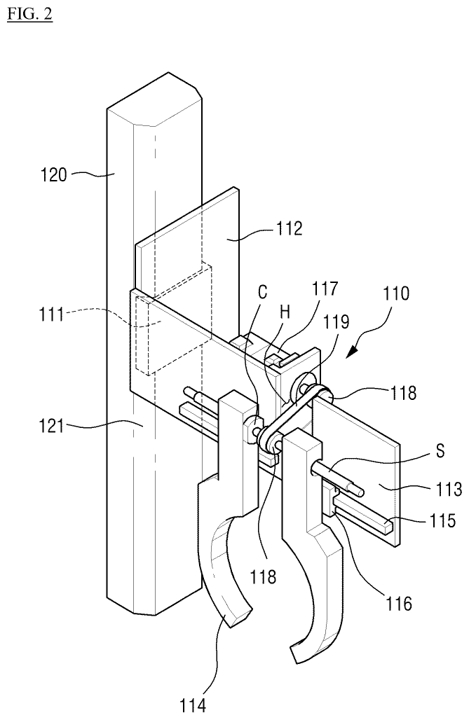

FIG. 2 is a schematic partial perspective view illustrating a gripper unit of a reel take-out device according to some embodiments of the present disclosure.

Referring to FIGS. 1 and 2, the gripper unit 110 may grip a reel core 11 of one or more reels 10 sequentially inserted into a shaft 2 of a transport cart 1.

The gripper unit 110 may include a coupling plate 112, an extension plate 113, a gripper 114, an LM guide rail 115, an LM block 116, a rotary shaft S, a driving motor 117, a driving pulley 118, and a timing belt 119.

The coupling plate 112 may be coupled to an elevating block 111 of the first driving unit 120. The coupling plate 112 may have a shape in which its other side along a third direction D3 is coupled to the elevating block 111. The coupling plate 112 may ascend or descend simultaneously with the elevation of the elevating block 111.

In this case, the elevating blocks 111 of the first driving unit 120 may have a shape coupled to an elevating guide rails 121 disposed on both sides of the first driving unit 120 along a second direction D2. The elevating block 111 may be coupled to the elevating guide rail 121 to ascend or descend along a first direction D1.

The extension plate 113 may have a shape extended from the coupling plate 112. The extension plate 113 may be extended from one side of the coupling plate 112 along the second direction D2. The extension plate 112 may have a shape extended from the coupling plate 112 along the third direction D3.

The extension plate 112 may include an extension groove H formed in a central portion along the third direction D3. The timing belt 119 may have a shape extended along the second direction D2 through the extension groove H.

The gripper 114 may be provided on the extension plate 113. The gripper 114 may be disposed on one side of the extension plate 113 toward the transport cart 1 in the second direction D2. The gripper 114 may be extended from the extension plate 113 downward toward the reel 10 along the first direction D1.

The grippers 114 may be disposed in pairs provided to be spaced apart from each other along the third direction D3.

The pair of grippers 114 may grip the reel core 11. The pair of grippers 114 may surround and grip an outer circumferential surface of the reel core 11.

The LM guide rail 115 may be provided on the extension plate 113. The LM guide rail 115 may be disposed on one side of the extension plate 113 along the second direction D2. The LM guide rail 115 may be disposed at a lower end of the extension plate 113 along the first direction D1. The LM guide rails 115 may be provided in pairs spaced apart from each other along the third direction D3 in the extension plate 113.

The pair of LM guide rails 115 may be extended along the third direction D3.

The LM blocks 116 may be provided on the pair of LM guide rails 115, respectively. The LM blocks 116 may be disposed to be linearly movable along the third direction D3.

Each of the pair of LM blocks 116 may have a shape in which the gripper 114 is coupled to one side along the second direction D2.

The rotary shaft S may be provided on the extension plate 113. The rotary shaft S may be disposed on one side of the extension plate 113 along the second direction D2. The rotary shaft S may have a shape provided above the LM guide rail 115 along the first direction D1.

The rotary shaft S may be coupled to the pair of grippers 114 while passing through the pair of grippers 114. The rotary shaft S may be coupled to the pair of grippers 114 through a coupler C. The coupler C may hold the rotary shaft S to rotate in a predetermined axial direction even though a concentric (concentric axis) of the rotary shaft S is misaligned during movement of the pair of grippers 114.

The rotary shaft S may have a shape connecting the pair of grippers S. The rotary shaft S may move the pair of grippers S in the third direction D3 through a driving force transferred by the driving motor 117.

The rotary shaft S may have a ball screw shape. The rotary shaft S may convert a rotating movement of the driving motor 117 into a linear movement of the pair of grippers 114 disposed on the rotary shaft S.

The rotary shaft S may be rotated by the driving motor 117 to linearly move the pair of grippers 114 in the third direction D3.

The rotary shaft S may simultaneously move the pair of grippers 114 in the third direction D3.

The rotary shaft S may move any one of the pair of grippers 114 from one side to the other side along the third direction D3. The rotary shaft S may move the other one of the pair of grippers 114 from the other side to one side along the third direction D3.

Also, the rotary shaft S may move any one of the pair of grippers 114 from the other side to one side along the third direction D3. The rotary shaft S may move the other one of the pair of grippers 114 from one side to the other side along the third direction D3.

As a result, the rotary shaft S may widen or narrow a gap at which the pair of grippers 114 are spaced apart from each other.

The rotary shaft S may narrow the gap at which the pair of grippers 114 are spaced apart from each other, so that the pair of grippers 114 may grip the outer circumferential surface of the reel core 11.

The rotary shaft S may widen the gap between the pair of grippers 114 to release the grip of the reel core 11.

The driving motor 117 may be provided on the other side of the extension plate 113 along the second direction D2. The driving motor 117 may be disposed on an opposite side of the pair of grippers 114 on the extension plate 113. The driving motor 117 is connected to the rotary shaft S to transfer the driving force to the rotary shaft S. The driving motor 117 is connected to the rotary shaft S through the driving pulley 118.

The driving motor 117 generates a rotational force to transfer the driving force to the rotary shaft S having the ball screw shape. The driving motor 117 may be connected to the controller 140. The controller 140 may actuate the driving motor 117. When the driving motor 117 is driven by the controller 140, the gap formed by the pair of grippers 114 may be widened or narrowed through the rotary shaft S.

The driving pulley 118 may be provided on the rotary shaft S. The driving pulley 118 may be also provided on the shaft of the driving motor 117.

The timing belt 119 may have a shape connecting the driving pulley 119 of the rotary shaft S to the driving pulley 118 of the driving motor 117. The timing belt 119 may be extended and connected from the driving pulley 118 of the driving motor 117 to the driving pulley 118 of the rotary shaft S along the second direction D2 through the extension groove H of the extension plate 113. The timing belt 119 may rotate the rotary shaft S by transferring the driving force from the driving motor 117 to the rotary shaft S.

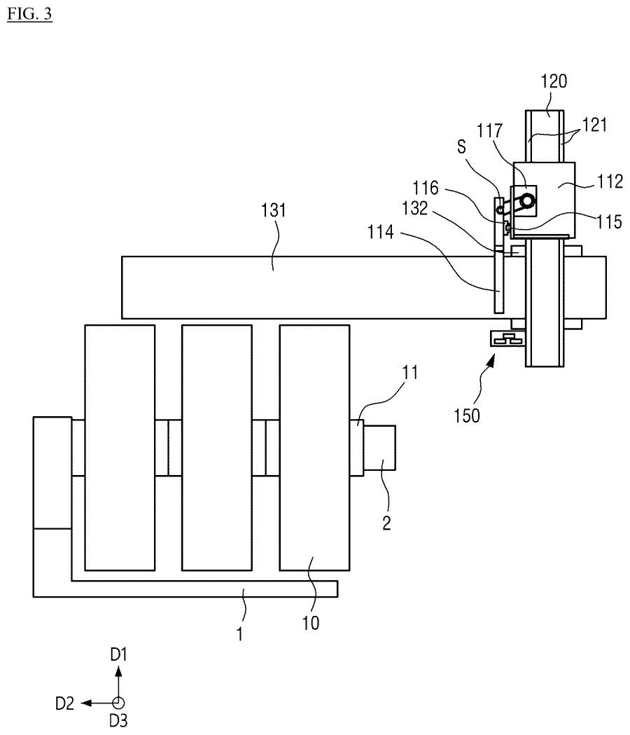

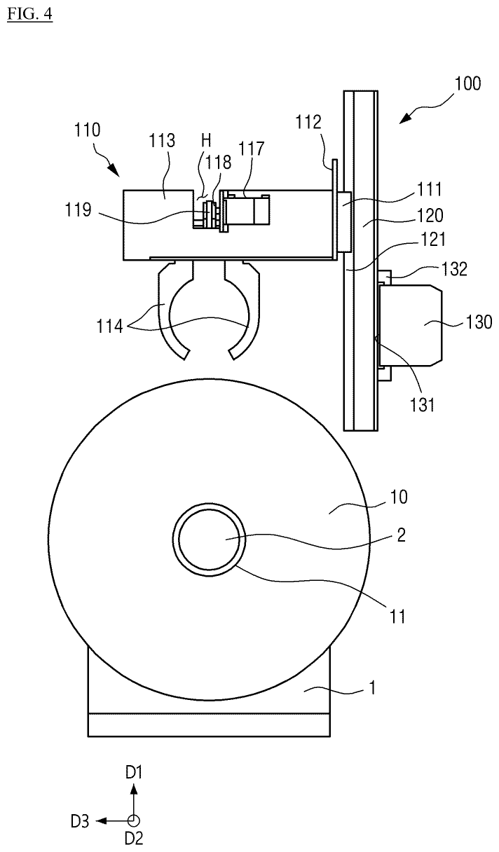

FIGS. 3 and 4 are schematic cross-sectional views illustrating a reel take-out device according to some embodiments of the present disclosure.

Referring to FIGS. 1 to 4, the first driving unit 120 may be disposed along the first direction D1. The first driving unit 120 may be in the form of a frame having a predetermined thickness along the third direction D3.

The first driving unit 120 may include an elevating block 111. The elevating block 111 may have a shape coupled to the elevating guide rails 121 disposed on both sides of the first driving unit 120 along the second direction D2. The elevating block 111 may be coupled to the elevating guide rail 121 to ascend or descend along the first direction D1.

The elevating block 111 may be connected to a separate power source. In this case, the power source may have a shape connected to the controller 140. The elevating block 111 may be driven to ascend and descend by the controller 140.

The first driving unit 120 may include elevating guide rails 121 formed on both sides along the second direction D2. The first driving unit 120 may be connected to the gripper unit 110. The first driving unit 120 may have a shape connected to the gripper unit 110 through the elevating block 111.

The elevating guide rail 121 may have a shape to which the elevating block 111 is coupled to ascend or descend. The gripper unit 110 may be elevated along the first direction D1 through the elevating block 111 coupled to the elevating guide rail 121.

The second driving unit 130 may be disposed along the second direction D2.

The second driving unit 130 may be in the form of a frame having a predetermined thickness along the third direction D3.

The second driving unit 130 may include a driving guide rail 131 disposed on one side directed toward the gripper unit 110 along the third direction D3. The second driving unit 130 may be connected to the first driving unit 120. The second driving unit 130 may include a driving block 132 movably coupled to the driving guide rail 131 in the second direction D2. The second driving unit 130 may have a shape connected to the first driving unit 120 through the driving block 132. The first driving unit 120 may be coupled to one side and the other side of the driving block 132 along the first direction D1.

The driving block 132 may have a shape to which the other side of the first driving unit 120 is coupled along the third direction D3. The driving block 132 may move the first driving unit 120 in the second direction D2 while being coupled to the driving guide rail 131. The driving block 132 may be connected to a separate power source. In this case, the power source may have a shape connected to the controller 140. The driving block 132 may be moved by the controller 140 along the second direction D2.

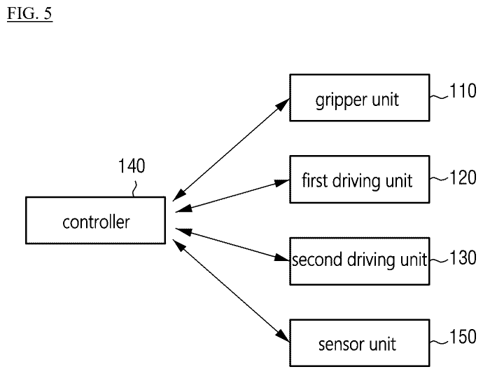

FIG. 5 is a schematic conceptual view illustrating a connection relation between a controller of a reel take-out device and each component according to some embodiments of the present disclosure.

Referring to FIGS. 1 to 5, the controller 140 may be connected to the gripper unit 110, the first driving unit 120 and the second driving unit 130.

The controller 140 may be connected to the driving block 132 of the second driving unit 120 to move the first driving unit 120 in the second direction D2.

The controller 140 may be connected to the elevating block 111 of the first driving unit 120 so that the first driving unit 120 may elevate the gripper unit 110 in the first direction D2.

The controller 140 is connected to the driving motor 117 of the gripper unit 110 so that the pair of grippers 114 may grip the reel core 11 or release the grip of the reel core 11.

The controller 140 may control the first driving unit 120 and the second driving unit 130 to drive them at the same time in a state that the gripper unit 110 grips the reel core 11, so that the reel 10 may be taken out in response to the arrangement angle of the shaft 2 according to the second direction D2.

That is, the controller 140 may simultaneously control the elevating block 111 and the driving block 132 in response to the arrangement angle of the shaft 2 according to the second direction D2 so that the reel 10 may be corrected in an upward or downward angle along the first direction D1 and thus may be taken out obliquely.

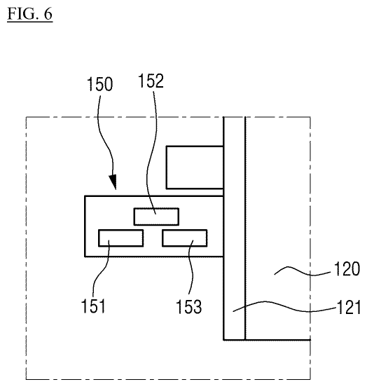

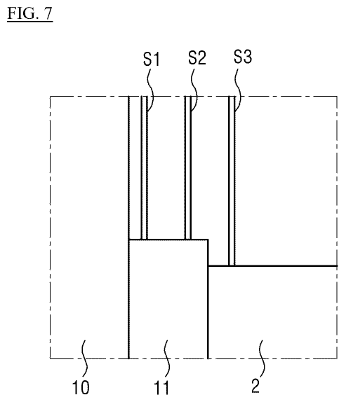

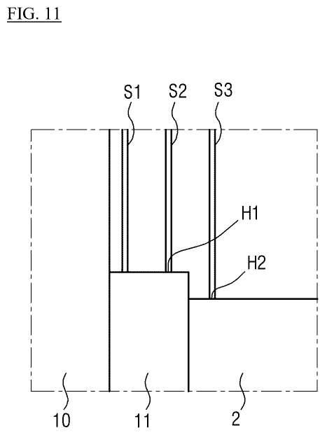

FIG. 6 is a schematic partial cross-sectional view illustrating a sensor unit of a reel take-out device according to some embodiments of the present disclosure. FIGS. 7 to 10 are schematic partial cross-sectional views illustrating that sensors of a sensor unit of a reel take-out device according to some embodiments of the present disclosure sense a winding defect state of a reel and the degree of excessive or slight movement of a first driving unit. FIG. 11 is a partial cross-sectional view illustrating that a sensor unit of a reel take-out device according to some embodiments of the present disclosure senses heights of a reel core and a shaft.

Referring to FIGS. 6 to 11, the reel take-out device 100 according to some embodiments of the present disclosure may further include a sensor unit 150 disposed to be protruded from a lower portion of the first driving unit 120 along the first direction D1 to one side toward the transport cart 1 along the second direction D2.

The sensor unit 150 may be connected to the controller 140. The sensor unit 150 may include a first sensor 151, a second sensor 152, and a third sensor 153.

The first sensor 151 may be connected to the controller 140. The first sensor 151 may have a form of a displacement sensor.

The first sensor 151 maps a position to which the reel 10 is fitted while counting the number of one or more reels 10 fitted to the shaft 2 in accordance with the movement of the first driving unit 120 in the second direction D2 by the second driving unit 130.

In FIGS. 7 to 11, a reference numeral “S1” means a sensing line S1 sensed by the first sensor 151 to map the number of reels 10 and the position to which the reels 10 are fitted.

The second sensor 152 may be connected to the controller 140. The second sensor 152 may have a form of a displacement sensor.

The second sensor 152 senses the outer circumferential surface of the reel core 11.

In FIGS. 7 to 11, a reference numeral “S2” means a sensing line S2 sensed by the second sensor 151 to sense the outer circumferential surface of the reel core 11.

The third sensor 153 may be connected to the controller 140. The third sensor 153 may have a form of a displacement sensor.

The third sensor 153 senses an outer circumferential surface of the shaft 2.

In FIGS. 7 to 11, a reference numeral “S3” means a sensing line S3 sensed by the third sensor 151 to sense the outer circumferential surface of the shaft 2.

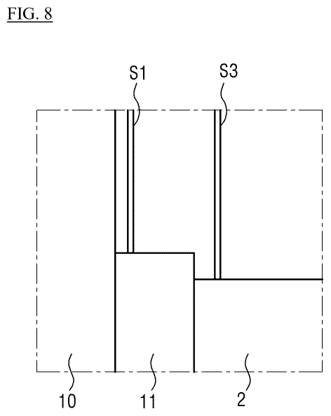

Referring to FIG. 8, when the winding state of the reel 10 is a defective state such as an oblique state, the controller 140 may determine an error state that the second sensor 152 does not sense the outer circumferential surface of the reel core 11, which is covered by the reel 10.

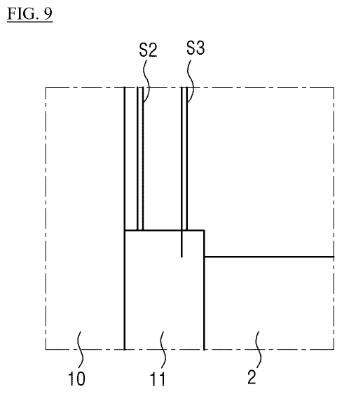

Referring to FIG. 9, when the first driving unit 120 is excessively moved to one side along the second direction D2, the controller 140 may control the second driving unit 130 by determining an error state that both the second sensor 152 and the third sensor 153 sense the outer circumferential surface of the reel core 11, thereby moving the first driving unit 120 to the other side along the second direction D2.

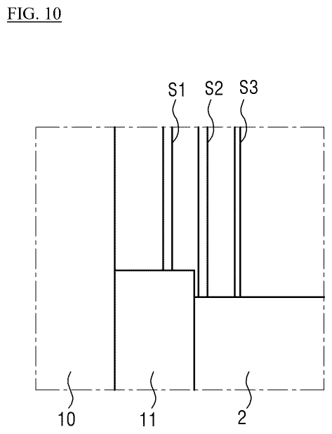

Referring to FIG. 10, when the first driving unit 120 is slightly moved to one side along the second direction D2, the controller 140 may control the second riving unit 130 by determining an error state that both the second sensor 152 and the third sensor 153 sense the outer circumferential surface of the shaft 2, thereby further moving the first driving unit 120 to one side along the second direction D2.

Referring to FIG. 11, the controller 140 may calculate a difference value between a height H1 of the reel core 11, which is sensed by the second sensor 152, and a height H2 of the shaft 2, which is sensed by the third sensor 153.

In a state that the gripper unit 110 grips the reel core 11, the controller 140 controls the first and second driving units 120 and 130 to be driven simultaneously in accordance with the difference value between the heights H1 and H2 of the reel core 11 and the shaft 2, so that the reel 10 may be taken out in response to the arrangement angle of the shaft 2 according to the second direction D2.

That is, in a state that the pair of grippers 114 grip the reel core 11, the controller 140 may simultaneously control the elevating block 111 and the driving block 132 in accordance with the height difference between the height H1 of the reel core 11 and the height of the shaft 2, so that the reel 10 may be corrected at an upward or downward angle along the first direction D1 in response to the arrangement angle of the shaft 2 along the second direction D2, thereby obliquely taking out the reel 10.

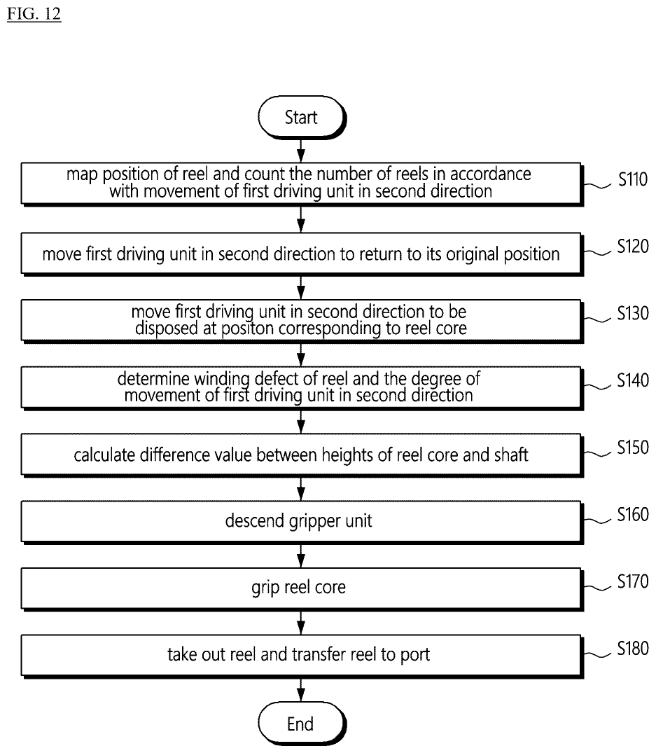

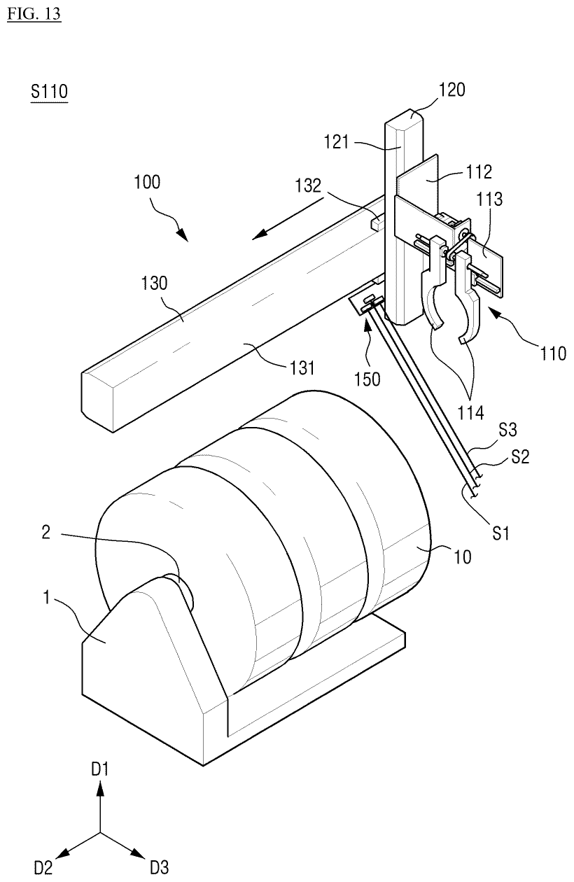

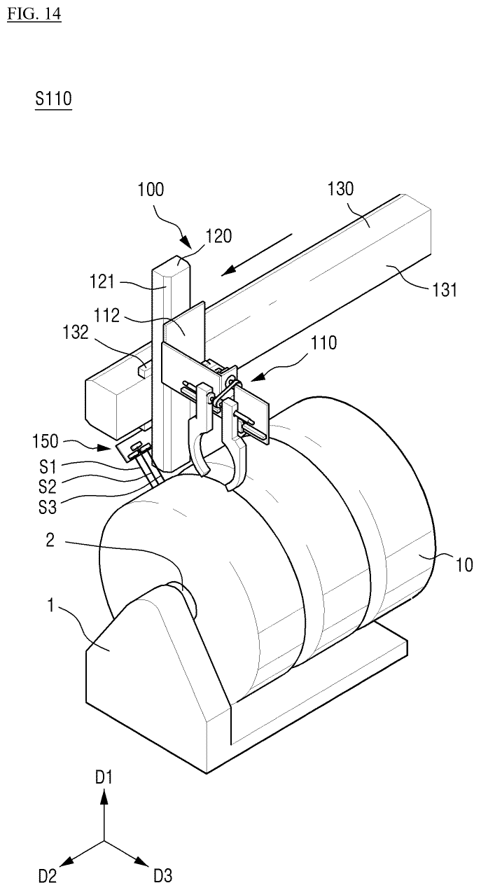

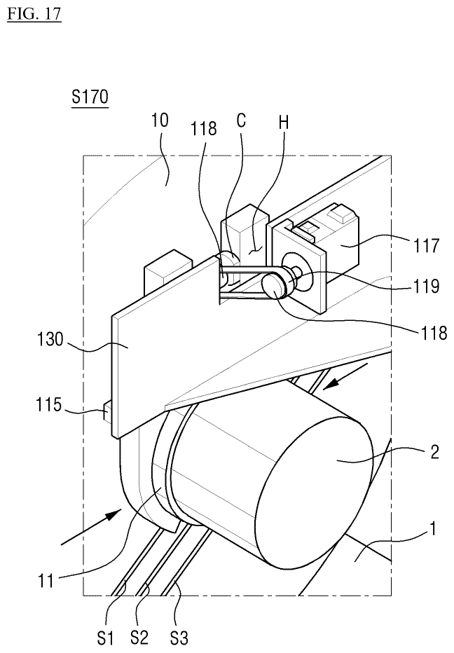

FIG. 12 is a schematic flow chart illustrating a reel take-out method according to some embodiments of the present disclosure. FIGS. 13 to 18 are schematic perspective views illustrating a reel take-out method according to some embodiments of the present disclosure.

Referring to FIGS. 12 to 14, the second driving unit 130 is first driven by the controller 140 so that the first driving unit 120 is moved to one side along the second direction D2, and the first sensor 151 of the sensor unit 150 maps the position to which one or more reels 10 are fitted, while counting the number of one or more reels 10 fitted to the shaft 2 of the transport cart 1. (S110).

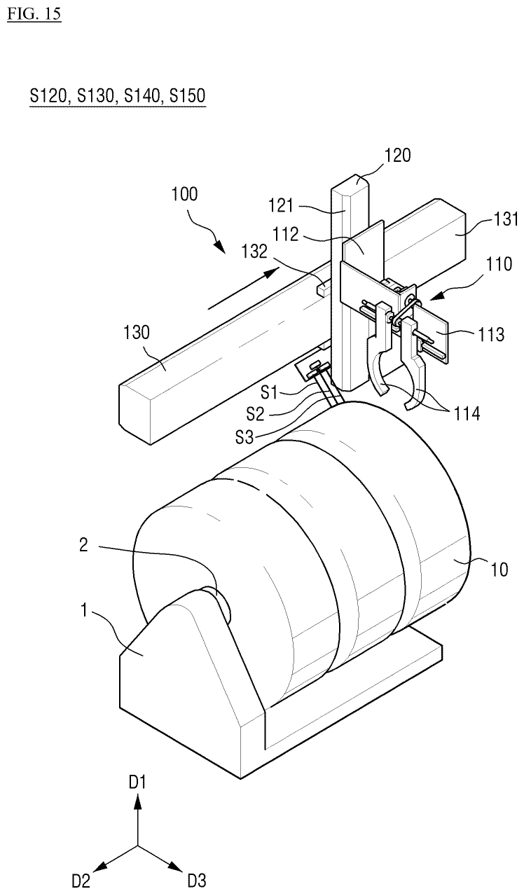

Referring to FIGS. 12 and 15, when the number of reels 10 is counted and mapping of the position to which the reels 10 are fitted is completed, the second driving unit 130 is driven again by the controller 140 so that the first driving unit 120 is moved back to the other side along the second direction and returns to its original position (S120).

After the first driving unit 120 returns to its original position, the second driving unit 130 is driven again by the controller 140 to take out the reel 10, so that the first driving unit 120 moves to one side along the second direction D2.

At this time, the first driving unit 120 is disposed at a position corresponding to the reel core 11 of the reel 10 on the other side of the shaft 2 along the second direction (S130).

The controller 140 stops driving of the second driving unit 130.

Subsequently, the controller 140 determines a winding defect of the reel 10 and the degree of excessive or slight movement of the first driving unit 120 along the second direction D2 through sensing of the second sensor 152 and the third sensor 153 of the sensor unit 150 (S140).

The controller 140 calculates a difference value between the height of the reel core 11 and the height of the shaft 2, which are sensed by the second sensor 152 and the third sensor 153 (S150).

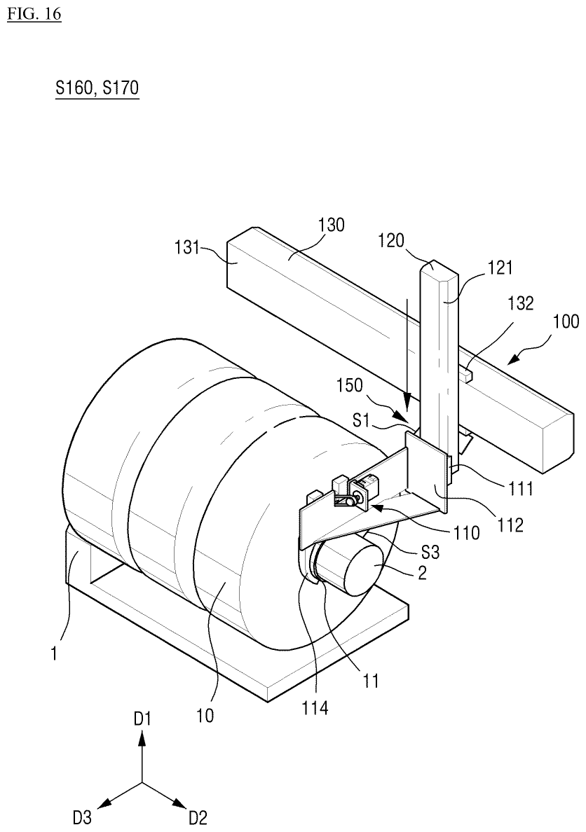

Referring to FIGS. 12 and 16, the elevating block 111 is driven by the controller 140 so that the gripper unit 110 descends from the first driving unit 120 (S160).

Referring to FIGS. 12, 16, and 17, the drive motor 117 is driven by the controller 140 so that the pair of grippers 114 of the gripper unit 140 grip the reel core 11 (S170).

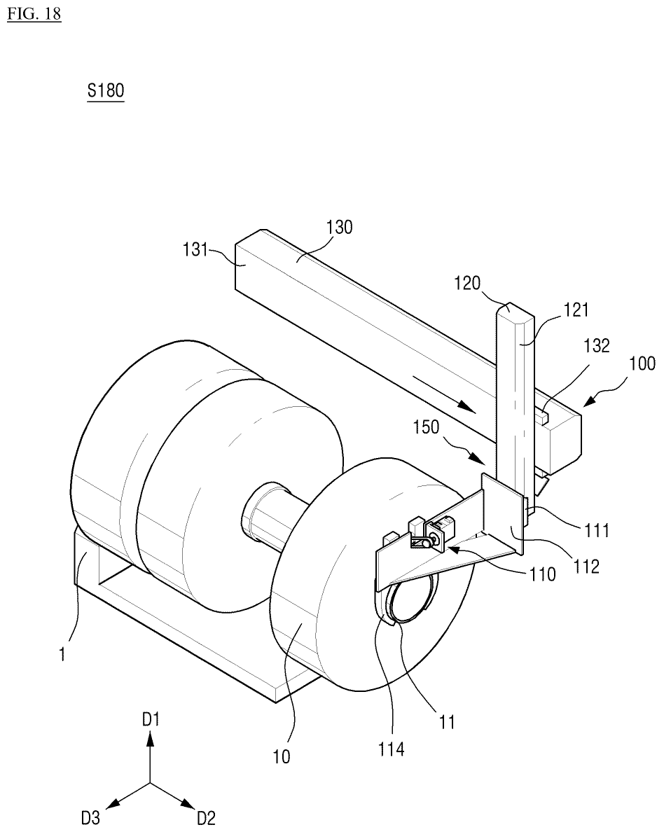

Referring to FIGS. 12 and 18, the controller controls the first and second driving units 120 and 130 to be simultaneously driven in accordance with the difference value between the heights of the reel core 11 and the shaft 2, so that the reel 10 is taken out in response to the arrangement angle of the shaft 2 along the second direction D2 and then transferred to a port (S180).

That is, in a state that the pair of grippers 114 grip the reel core 11, the elevating block 111 and the driving block 132 may be simultaneously controlled through the controller 140 in accordance with the height difference between the height H1 of the reel core 11 and the height of the shaft 2, so that the reel 10 is corrected at an upward or downward angle along the first direction D1 in response to the arrangement angle of the shaft 2 along the second direction D2 and then is obliquely taken out.

As described above, in the reel take-out device and method according to some embodiments of the present disclosure, the difference value between the heights of the reel core 11 and the shaft 2 is calculated by the sensor unit 150, and the first and second driving units 120 and 130 are controlled to be simultaneously in accordance with the difference value between the heights so that the reel 10 may be taken out in response to the arrangement angle of the shaft 2 of the transport cart 1, whereby the reel 10 may be prevented from being damaged and efficiency of the take-out work of the reel 10 may be increased.

Although the embodiments of the present disclosure have been described with reference to the accompanying drawings, it will be apparent to those skilled in the art that the present disclosure can be embodied in other specific forms without departing from the technical spirits and essential characteristics of the present disclosure. Thus, the above-described embodiments are to be considered in all respects as illustrative and not restrictive.

What is claimed is:

1. A reel take-out device comprising:
a gripper unit gripping a reel core of one or more reels sequentially fitted to a shaft of a transport cart;
a first driving unit connected to the gripper unit to elevate the gripper unit in a first direction;
a second driving unit connected to the first driving unit to move the first driving unit in a second direction; and
a controller controlling driving of the gripper unit, the first driving unit and the second driving unit,
wherein the controller controls the first and second driving units to be simultaneously driven to take out the reel in response to an arrangement angle of the shaft along the second direction in a state that the gripper unit grips the reel core.

2. The reel take-out device of claim 1, wherein the gripper unit includes:
a coupling plate coupled to an elevating block that is coupled to an elevating guide rail along the first direction, which is disposed on both sides of the first driving unit along the second direction;
an extension plate having a shape extended from the coupling plate along a third direction; and
a pair of grippers disposed on one side of the extension plate, which is directed toward the transport cart along the second direction, and provided to be spaced apart from each other along the third direction.

3. The reel take-out device of claim 2, wherein the gripper unit includes:
a pair of LM guide rails spaced apart from each other along the third direction on one side surface of the extension plate along the second direction; and
an LM block disposed on each of the pair of LM guide rails to linearly move along the third direction, having one side to which the gripper is coupled along the second direction.

4. The reel take-out device of claim 3, wherein the gripper unit includes:
a rotary shaft provided above the LM guide rail along the first direction on one side of the extension plate along the second direction and coupled to the pair of grippers through a coupler while passing through the pair of grippers;
a driving motor provided on the other side of the extension plate along the second direction;
a driving pulley provided on each of the rotary shaft and the driving motor; and
a timing belt connecting the driving pulley of the rotary shaft with the driving pulley of the driving motor.

5. The reel take-out device of claim 4, wherein the extension plate includes an extension groove formed in a central portion along the third direction, and the timing belt is extended from the driving pulley of the driving motor along the second direction and connected to the driving pulley of the rotary shaft through the extension groove.

6. The reel take-out device of claim 4, wherein the driving motor is connected to the controller.

7. The reel take-out device of claim 6, wherein a gap between the pair of grippers spaced apart from each other along the third direction is widened or narrowed along the third direction by driving of the driving motor.

8. The reel take-out device of claim 2, wherein the elevating block is connected to a power source, and
the power source is connected to the controller.

9. The reel take-out device of claim 2, wherein the second driving unit includes:
a driving guide rail disposed on one side directed toward the gripper unit along the third direction; and
a driving block coupled to the driving guide rail to move in the second direction.

10. The reel take-out device of claim 9, wherein the other side of the first driving unit along the third direction is coupled to the driving block so that the first driving unit moves along the second direction.

11. The reel take-out device of claim 10, wherein the driving block is connected to a power source, and
the power source is connected to the controller.

12. The reel take-out device of claim 1, further comprising a sensor unit protruded from a lower portion of the first driving unit along the first direction toward one side directed toward the transport cart along the second direction.

13. The reel take-out device of claim 12, wherein the sensor unit is connected to the controller.

14. The reel take-out device of claim 12, wherein the sensor unit includes
a first sensor mapping a position to which the reel is fitted, while counting the number of the reels fitted to the shaft in accordance with movement of the first driving unit in the second direction by the second driving unit,
a second sensor sensing an outer circumferential surface of the reel core, and
a third sensor sensing an outer circumferential surface of the shaft.

15. The reel take-out device of claim 14, wherein the first sensor, the second sensor and the third sensor have a form of a displacement sensor,
the controller calculates a difference value between heights of the reel core and the shaft, which are sensed by the second sensor and the third sensor, and
controls the first and second driving units to be simultaneously driven in accordance with the difference value to take out the reel in response to an arrangement angle of the shaft along the second direction in a state that the gripper unit grips the reel core.

16. The reel take-out device of claim 15, wherein the controller determines an error state that the second sensor does not sense the outer circumferential surface of the reel core, which is covered by the reel, during a winding defect of the reel.

17. The reel take-out device of claim 15, wherein the controller determines an error state that both the second sensor and the third sensor sense the outer circumferential surface of the reel core when the first driving unit is excessively moved in the second direction.

18. The reel take-out device of claim 15, wherein the controller determines an error state that both the second sensor and the third sensor sense the outer circumferential surface of the shaft when the first driving unit is slightly moved in the second direction.

19. A reel take-out device comprising:
a gripper unit gripping a reel core of one or more reels sequentially fitted to a shaft of a transport cart;
a first driving unit connected to the gripper unit to elevate the gripper unit in a first direction;
a second driving unit connected to the first driving unit to move the first driving unit in a second direction;
a controller controlling driving of the gripper unit, the first driving unit and the second driving unit; and
a sensor unit protruded from a lower portion of the first driving unit along the first direction toward one side directed toward the transport cart along the second direction,
wherein the sensor unit is connected to the controller, and
includes a first sensor mapping a position to which the reel is fitted, while counting the number of the reels fitted to the shaft in accordance with movement of the first driving unit in the second direction by the second driving unit, a second sensor sensing an outer circumferential surface of the reel core, and a third sensor sensing an outer circumferential surface of the shaft,
the first sensor, the second sensor and the third sensor have a form of a displacement sensor,
the controller determines an error state that the second sensor does not sense the outer circumferential surface of the reel core, which is covered by the reel, during a winding defect of the reel,
determines an error state that both the second sensor and the third sensor sense the outer circumferential surface of the reel core when the first driving unit is excessively moved in the second direction,
determines an error state that both the second sensor and the third sensor sense the outer circumferential surface of the shaft when the first driving unit is slightly moved in the second direction,
calculates a difference value between heights of the reel core and the shaft, which are sensed by the second sensor and the third sensor, and
controls the first and second driving units to be simultaneously driven in accordance with the difference value to take out the reel in response to an arrangement angle of the shaft along the second direction in a state that the gripper unit grips the reel core.

20. A reel take-out method comprising:
providing a reel take-out device including a gripper unit gripping a reel core of one or more reels sequentially fitted to a shaft of a transport cart; a first driving unit connected to the gripper unit to elevate the gripper unit in a first direction; a second driving unit connected to the first driving unit to move the first driving unit in a second direction; a controller controlling driving of the gripper unit, the first driving unit and the second driving unit; and a sensor unit protruded from a lower portion of the first driving unit along the first direction toward one side directed toward the transport cart along the second direction;
mapping a position to which the reel is fitted, while counting the number of the reels fitted to the shaft by a first sensor of the sensor unit in accordance with movement of the first driving unit to one side along the second direction by the controller;
moving the first driving unit to the other side again along the second direction by the controller to return to its original position;
moving the first driving unit along the second direction by the controller so that the first driving unit is disposed at a positon corresponding to the reel core of the reel on the other side of the shaft along the second direction;
determining a winding defect of the reel and excessive or slight movement of the first driving unit along the second direction through sensing of a second sensor and a third sensor of the sensor unit by the controller;
calculating a difference value between heights of the reel core and the shaft, which are sensed by the second sensor and the third sensor, by the controller;
descending the gripper unit from the first driving unit by the controller;
gripping the reel core by the gripper unit through the controller; and
controlling the first and second driving units to be simultaneously driven in accordance with the difference value through the controller to take out the reel in response to an arrangement angle of the shaft along the second direction and transfer the reel to a port.
